(19) United States
(12) Patent Application Publication
(10) Pub. No.: US 2011/0235505 A1
(43) Pub. Date: Sep. 29, 2011

(54) Efficient deployment of mobility management entity (MME) with stateful geo-redundancy

(75) Inventors: Srinivas Eswara, Garland, TX (US); Michael Brown, McKinney, TX (US); Carlos Molina, Plano, TX (US); Haibo Qian, Plano, TX (US)

(73) Assignee: HITACHI, LTD., Tokyo (JP)

(21) Appl. No.: 12/956,267

(22) Filed: Nov. 30, 2010

Related U.S. Application Data
(60) Provisional application No. 61/318,399, filed on Mar. 29, 2010.

(51) Int. Cl. H04L 12/26

(52) U.S. Cl. 370/221

(57) ABSTRACT

This disclosure describes a method to provide stateful geographic redundancy for the LTE MME (Mobility Management Entity) function of the 3GPP E-UTRAN Evolved Packet core (EPC). The method provides MME many-to-one (“n:1”) stateful redundancy by building upon the S1-Flex architecture, which enables a MME Pool Area to be defined as an area within which a UE (User Equipment) may be served without need to change the serving MME. Geographic redundancy is achieved by utilizing a standby MME node deployed to backup a pool of MME nodes, with the standby MME node designed to handle the large volume of journaling or synchronization messages from all the MME nodes in the pool. The standby MME node takes over the personality and responsibility of any MME node in the pool that has failed, with minimal impact to subscribers that were being served by that failed MME node.

This application is based on and claims priority to Ser. No. 61/318,399, filed Mar. 29, 2010.

### BACKGROUND

1. Technical Field

This disclosure relates generally to mobile broadband networking technologies, such as the Evolved 3GPP Packet Switched Domain that provides IP connectivity using the Evolved Universal Terrestrial Radio Access Network (E-UTRAN).

2. Related Art

Evolved Packet Core (EPC) is the Internet Protocol (IP)-based core network defined by 3GPP in Release 8 for use by Long-Term Evolution (LTE) and other wireless network access technologies. The goal of EPC is to provide an all-IP core network architecture to efficiently give access to various services. The LTE MME (Mobility Management Entity) function is an important part of the network, as it is the anchor for mobile devices (User Equipment or “UE”) as they move across the system within the geographic area covered by a MME node. EPC comprises a MME and a set of access-agnostic Gateways for routing of user datagrams. More generally, General Packet Radio Service (GPRS) enhancements for E-UTRAN access are described in 3GPP Mobile Broadband Standard Reference Specification 3GPP TS 23.401 v8.9.0 (2010-03). Familiarity with this and related standards is presumed.

Mobile operators are looking for networks that are very reliable, yet cost efficient, as revenue per subscriber goes down, while more and more critical services are offered on the mobile network. The expectation is that mobile wireless networks will exhibit the same level of reliability as today's wire line networks.

Recent 3GPP standards have defined features, such as S1-Flex, to enable distributed deployments for geographic redundancy. If a MME node fails, S1-Flex enables high availability, because the users can re-register and reactivate on a new MME node. Nevertheless, when the user moves to a new MME node, all the existing sessions, calls in progress, and the like, get dropped. The reason this is the case is that the S1-Flex mechanism does not provide for stateful redundancy. A possible approach to address this problem is to run a standby node to back up each MME. Deploying a backup MME node for each deployed MME node, however, is very expensive both from a capital expenditure perspective as well as from an operational expenditure perspective.

The subject matter herein addresses this problem.

### BRIEF SUMMARY

This disclosure describes a method to provide stateful geographic redundancy for the LTE MME (Mobility Management Entity) function of the 3GPP E-UTRAN Evolved Packet core (EPC). The method provides MME many-to-one (“n:1”) stateful redundancy by building upon the S1-Flex architecture, which enables a MME Pool Area to be defined as an area within which a UE (User Equipment) may be served without need to change the serving MME. As used herein, “stateful” refers to the state of each subscriber UE relating to its connection with the network and the sessions associated with that UE. Geographic redundancy is achieved by utilizing a standby MME node deployed to back-up a pool of MME nodes, with the standby MME node designed to handle the large volume of journaling or synchronization messages from all the MME nodes in the pool. The standby MME node takes over the personality and responsibility of any MME node in the pool that has failed, with minimal impact to subscribers that were being served by that failed MME node. According to another aspect, when the failed MME node is brought back into service, it may then take on the role of the standby.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 is a simplified block diagram of an MME pool having an associated standby MME according to the teachings of this disclosure;

FIG. 2 illustrates a representative memory allocation in the backup MME and the journal data structure that is stored therein;

FIG. 3 is a time sequence diagram illustrating MME journaling when the MMEs are operating normally; and

FIG. 4 is a time sequence diagram illustrating the MME backup taking over responsibility for a failed MME according to the teachings herein.

### DETAILED DESCRIPTION

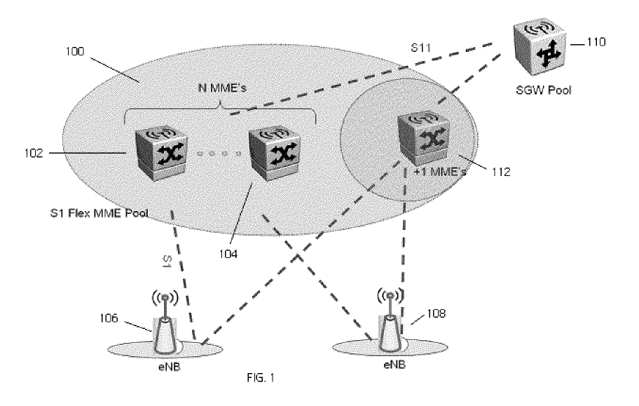

According to the 3GPP Standard, a MME Pool Area is defined as an area within which a UE may be served without need to change the serving MME. An MME Pool Area is served by one or more MMEs (“pool of MMEs”) in parallel. FIG. 1 illustrates an S1-Flex MME pool area 100 comprising “n” number of MMEs, such as MME 102 and 104. The network includes multiple Evolved Node B (eNB) nodes, two of which are shown at 106 and 108. The eNB is a base station that handles radio communications with multiple devices in the cell and carries out radio resource management and handover decisions. The MME is the main signaling node in the EPC. It is the key control-node for the LTE access-network. The MME is responsible for initiating paging and authentication of the mobile device. It also keeps location information at a Tracking Area level for each user, and it is involved in choosing the right gateway during the initial registration process. More specifically, the MME, is responsible for idle mode UE (User Equipment) tracking and paging procedure including retransmissions. The MME also is involved in the bearer activation/deactivation process, and it is also responsible for choosing the Serving Gateway (S-GW) for a UE at the initial attach and at the time of intra-LTE handover involving CN node relocation. As illustrated in FIG. 1, an MME connects to eNBs through the S1-MME interface and connects to a Serving Gateway (S-GW) pool 110 through a standard interface called S11 interface. Si is a standardized interface between eNB and the Evolved Packet Core (EPC). S1 has two types, S1-MME for exchange of signaling messages between the eNB and the MME, and S U for the transport of user datagrams between the eNB and the Serving Gateway (S-GW). The Serving Gateway is the main packet routing and forwarding node in EPC. it also plays the role of a mobility anchor in inter-eNB handovers. The multiple MMES are grouped together in the pool to meet increasing signaling load in the network. The MME also facilitates handover signaling between LTE and 2G/3G networks.

As illustrated in FIG. 1, according to this disclosure, for “n” MME nodes, at least one MME 112 is designated as a standby node capable of taking over any of the “n” MME nodes. The “n” MME nodes run in (or are otherwise associated with) an MME pool 100 and, as illustrated, the standby MME node 112 has Internet Protocol (IP) connectivity to all the eNode Bs 106 and 108 in the pool coverage area. Preferably, there is a given ratio of active MMEs to each standby node, and this ratio is determined by the number of subscribers served in the pool and the number of S1 interface connections supported by each eNB. In operation, the active “n” MME nodes in the pool area journal to the standby MME 112 stable registered user states or other synchronization messages. The standby MME 112 maintains a heartbeat with every active MME to detect nodal failures. Other “liveness” detection or request-response mechanisms may be used for this purpose. Upon failure detection on the MME to standby MME link, the standby MME 112 initiates a “takeover” phase. In the takeover phase, the standby MME takes on the personality of the failed MME and re-establishes S1 SCTP (Stream Control Transmission Protocol) association with the eNodeBs using the IP address of the failed MME. During this operation, INIT messaging is used to ensure that active UEs do not get released by eNodeB. This takeover process has minimal impact to active users. Upon recovery of the failed MME node, that node may be brought back into service.

According to another aspect of this disclosure, the previously-failed MME node is brought back into service as the standby node for the pool. Alternatively, if the deployment plan calls for the same node to be used as the standby node in normal conditions, users are moved back to the newly-recovered node in a controlled manner, e.g., by utilizing S1-Flex weighted distribution mechanisms on the eNodeB to quickly load the newly-recovered MME utilizing MME load distribution algorithms.

According to this disclosure, the standby MME node 112 takes over the personality of the failed MME node, by using one of several approaches: BGP routing data, or SCTP multi-homing.

In a first embodiment, involving BGP, the backup site and the other sites are connected via a BGP router to the access network and on S11 for the backup MME to take over the S1 IP address of the failed MME. In this approach, the latency of routing information propagation between the MME sites and the BGP router should be less than the S1 SCTP association timeout in the eNodeB (to prevent the eNodeB from releasing the SCTP association).

In a second embodiment, SCTP multi-homing from the eNB to both the active MMEs and the standby MME is utilized to obviate the BGP router on the S1 interface. On the S11 interface, proprietary signaling between the MME and S-GW is utilized to remove the need for BGP router on this interface as well.

The following provides additional details regarding the above-described technique. According to 3GPP TS 23.401, Section 5.7.2, an MME maintains Mobility Management (MM) context and EPS bearer context information for UEs in one of several states: ECM-IDLE, ECM CONNECTED, and EMM-DEREGISTERED states. During initialization of an active MME, and according to this disclosure, the MME's configuration information (including, without limitation, IP addresses on all interfaces, supported Tracking Areas (TA), SCTP association information, and the like) is sent to the backup MME. During normal operation, in addition to the configuration information, as contemplated herein all (or some subset thereof of) active MMEs preferably push to the backup MME the following additional information: MM “context” of registered UEs, such as associated HSS, authentication vectors, and so forth, as well as EPS Session Management (SM) information for UEs in stable state, such as PDN connection and bearer context information. If the backup MME comes into service after the active MMEs, bulk journaling information (configuration information, eNB and UE MM and EPS bearer context information) is sent to the backup MME from all the active MMEs upon return to service indication from the backup MME.

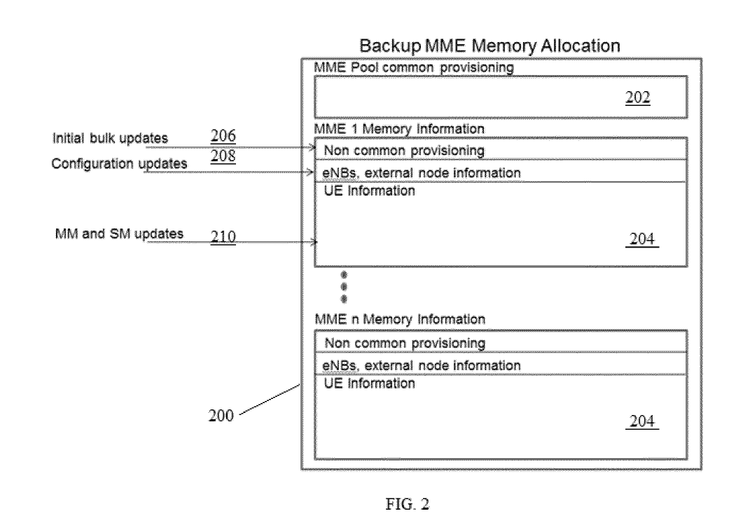

FIG. 2 illustrates a representative memory allocation in the backup MME for the journal data structure that is stored therein. Although in-memory storage of the journal data structure is shown, all or portions of this data structure also may be stored persistently in a data store (or data stores) associated with the backup MME. The memory 200 comprises a first portion 202 in which MME pool common provisioning data is stored, and “n” second portions 204 each corresponding to a particular MME that is journaling information to the backup MME. Typically, the information journaled to the backup MME typically comprises initial bulk updates 206, which represent non common provisioning data, configuration updates 208, such as eNBs, external node information, UE information, and the like as described above, as well as MM context and SM updates 210, also as described above.

Typically, the context fields for a UE (that are journaled to the MME) include one or more of the following: IMSI and related status, MSISDN, MM State (e.g., ECM-IDLE, ECM-CONNECTED, EMM-DEREGISTERED), GUTI, ME Identity, Tracking Area List, TAI of last TAU, E-UTRAN Cell Global Identity, E-UTRAN Cell Identity Age, CSG ID, CSG Membership, Access Mode, Authentication Vector, UE Radio Access Capability, MS Classmark, Supported Codecs, UE and MS Network Capability, UE Specific DRX Parameters, Selected NAS and AS Algorithms, key set identifiers and keys, CN operator ID, a Recovery indicator, Access Restriction information, OD for PS parameters, APN-OI replacement data, MME IP address for S11, MME TEID for S11, S-GW IP address for S11/S4, S-GW TEID for S11/S4, SGSN IP address for S3, SGSN TEID for S3, eNodeB address in Use, ENB UE s1AP ID, MME UE S1AP ID, Subscribed UE-AMBR, UE-AMBR, EPS Subscribed Charging Characteristics, Subscribed RSFP Index, RFSP Index in Use, Trace Reference, Trace Type, Trigger ID, OMC Identity, URRP-MME, and CSG Subscription Data. For each active PDN connection, the UE data may also include one or more of the following: APN in Use, APN Restriction, APN Subscribed, PDN Type, IP Address(es), ESP PDN Charging Characteristics, APN-OI Replacement, VPLMN Address Allowed, PDN GW Address In Use (Control Plane), PDN GW TEID for S5/S8 (Control Plane), MS Info Change Reporting Action, CSG Information Reporting Action, EPS subscribed QoS profile, Subscribed APN-AMBR, APN-AMBR, PDN GW GRE key for uplink traffic (user plane), and Default bearer. For each bearer within the PDN connection, one or more of the following are provided: EPS Bearer ID, TI, IP address for S1-u, TEID for S1u, PDD GW IP address for S5/S8 (user plane), EPS bearer QoS, and TFT.

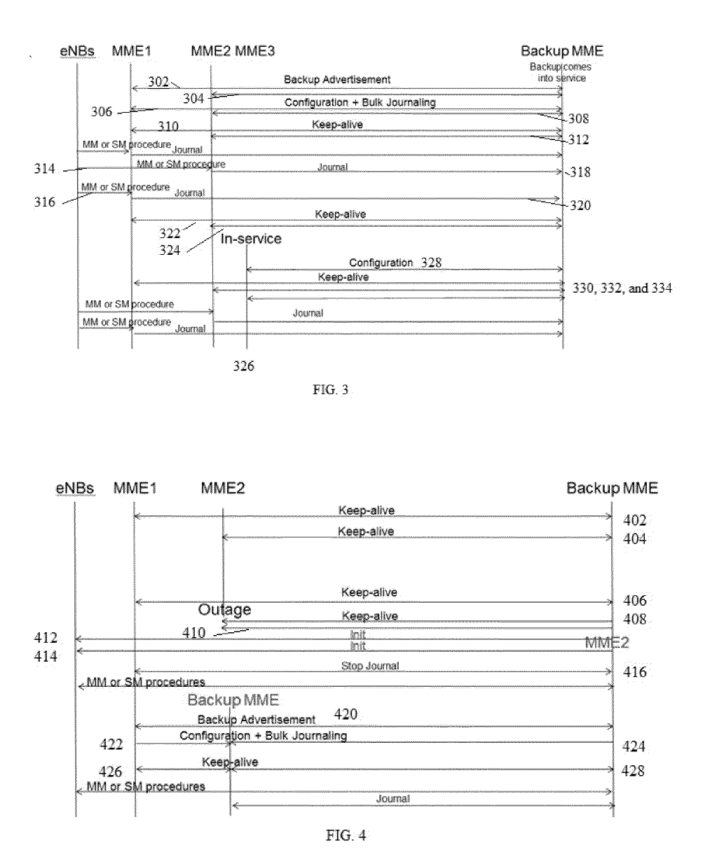

FIG. 3 is a time sequence diagram (as viewed from top to bottom) illustrating MME journaling when the MMEs are operating normally. In this example, “MME1” and “MME2”represent the MMEs 102 and 104 shown in FIG. 1, and “Backup MME” represents the MME 112 in FIG. 1. In this example, MME1 and MME2 are active at the time the Backup MME comes into service, which is represented at the beginning of the temporal sequence (the top portion of the drawing). MME3 comes into service later in the sequence, as will be described. Initially, the Backup MME advertises to each MME its status as a backup. These advertisement events are illustrated at 302 and 304. Each active MME then journals its configuration and bulk updates (as described in FIG. 2), as illustrated at event 306 and 308 in the diagram. Events 310 and 312 represent keep-alive messages that are issued from the Backup MME to each active MME, currently MME1 and MME2. During normal operation, and as UEs attach and de-attach, the one or more eNBs provide MMEs with MM and SM information, such as the information identified above. This operation is illustrated in FIG. 3 as events 314 and 316. According to this disclosure, and as described above, MME1 then journals this MM and SM data to the Backup MME as journal event 318, and MME2 journals the MM and SM data to the Backup MME as journal event 320. As the temporal sequence continues, Backup MME once again issues the keep-alive messages at event 322 and 324. Thereafter, and in this example, MME3 comes into service. This is event 326. As with the other active MMEs, MME3 then provides its configuration and bulk journaling data at event 328. Because there are now three active MMEs, keep-alive messages are now sent from the Backup MME to each such active MME, as represented by events 330, 332, and 334. The above sequence continues until such time as an outage occurs, as will now be described below.

FIG. 4 is a time sequence diagram illustrating the MME backup taking over responsibility for a failed MME according to the teachings herein. In this example, MME1 and MME2 presently are active, as indicated by the keep-alive events 402 and 404 in the upper portion of the timeline. Sometime later, Backup MME once again issues its keep-alive messages 406 and 408. MME1 is active and provides the Backup MME a suitable response. MME2, however, has been subject to an outage. Upon Keep-alive timeout and “n” retries 410, the Backup MME determines that it must now takeover responsibility for MME2. Thus, at events 412 and 414, the Backup MME sends INIT messages to all the eNBs associated with the failed MME. This operation enables the SCTP connections to stay intact. At event 416, the Backup MME instructs the other MME (MME1) in the pool to stop journaling, because the Backup MME is no longer acting as the backup with respect to the pool. Event 416 may occur before or after the INIT messages are sent to the eNBs. The Backup MME (which is no longer the backup for the pool) takes on the personality of MME2 that the Backup MME has now replaced in the pool. In one embodiment, and as noted above, this is accomplished by BGP routers between the MMEs and surrounding nodes enabling a transparent IP address takeover utilizing standard BGP updates. The Backup MME (now having taken over for failed MME2) may delete all the previously-journaled data belonging to the other active MMEs, although this is not a requirement.

Upon recovery, and in this example, the failed MME2 (as shown in FIG. 4) then takes on the personality of the backup MME and starts the journaling process once again by informing the active MMEs in the pool (now MME1, and the former Backup MME). To that end, MME2 (now operating at the backup) sends the backup advertisement messages at event 420. Each active MME in the pool sends its configuration and bulk journal data at events 422 and 424. The keep-alive messaging begins at events 426 and 428, and the normal journaling operations continue, as have been previously described. The journaling and backup takeover functions illustrated in FIGS. 3 and 4 preferably are implemented as software, e.g., processor-executed program instructions, in each of the machines as needed to implement the above-described operations. Each machine comprises associated data structures and utilities (e.g., communication routines, database routines, and the like) as needed to facilitate the communication, control and storage functions.

A standby MME that provides the functionality described herein is implemented in a machine comprising hardware and software systems. The described MME takeover functionality may be practiced, typically in software, on one or more such machines. Generalizing, a machine typically comprises commodity hardware and software, storage (e.g., disks, disk arrays, and the like) and memory (RAM, ROM, and the like). The particular machines used in the network are not a limitation. A given machine includes the described network interfaces (including, without limitation, the S1 and S11 interfaces) and software to connect the machine to other components in the radio access network in the usual manner. More generally, the techniques described herein are provided using a set of one or more computing-related entities (systems, machines, processes, programs, libraries, functions, or the like) that together facilitate or provide the inventive functionality described above. In a typical implementation, the MME comprises one or more computers. A representative machine comprises commodity hardware, an operating system, an application runtime environment, and a set of applications or processes and associated data, that provide the functionality of a given system or subsystem. As described, the functionality may be implemented in a standalone node, or across a distributed set of machines.

The stateful redundancy technique may be implemented to other nodes in the network, such as gateway nodes.

There is no requirement for a specific number “n” (of active MMEs) to be associated with the given standby MME node; as noted above, the value of “n” (which is >than 1) will depend on the number of subscribers served in the MME pool and the number of S1 interface connections supported by each eNB. In appropriate circumstances, a given standby MME node may even be associated with multiple different sets of “n” MMEs. There may be a plurality of standby MMEs per MME pool.

Having described our invention, what we now claim is set forth below.

1. A method to provide stateful redundancy in an evolved packet core (EPC) network, comprising:
associating a standby Mobility Management Entity (MME) with “n” other MMEs in an MME pool;
journaling to the standby MME stable registered user states from the other MMEs in the MME pool;
upon a failure of one of the “n” MMEs in the MME pool, having the standby MME take over responsibility for the failed MME.

2. The method as described in claim 1 wherein the standby MME maintains a connection to each of the “n” MMEs in the pool to detect the failure.

3. The method as described in claim 1 wherein the standby MME takes over responsibility for the failed MME by re-establishing an S1 interface SCTP association with one or more eNBs in the network using an IP address of the failed MME.

4. The method as described in claim 1 the failed MME has an S1 interface and the standby MME uses BGP data to take over responsibility for the failed MME.

5. The method as described in claim 1 wherein the failed MME has an S1 interface and the standby MME uses SCTP multi-homing to take over responsibility for the failed MME.

6. The method as described in claim 1 further including bringing the failed MME node back into service and using it as a new standby node for the MME pool.

7. The method as described in claim 1 wherein a value of “n” is determined by a number of subscribers served in the MME pool and a number of S1 interface connections supported by each eNB associated with the standby MME.

8. A Mobility Management Entity (MME) for use in an evolved packet core (EPC) network, comprising:
a processor;
a computer memory holding computer program instructions which when executed by the processor perform a method comprising:
associating the Mobility Management Entity with “n” other MMEs;
receiving registered user state data from the other MMEs; and
upon detecting a failure of one of the “n” MMEs in the MME pool, taking over responsibility for the failed MME.

9. The MME as described in claim 8 wherein the method includes monitoring an operating state of each of the other MMEs.

10. The MME as described in claim 8 wherein “n” is determined by a number of subscribers served by the other MMEs and a number of S1 interface connections supported by each eNodeB (eNB) associated with the standby MME.

11. A method to provide stateful redundancy in an evolved packet core (EPC) network having “n” MMEs in an MME pool, comprising:
journaling to a standby MME given data from the other MMEs in the MME pool; and
upon a failure of one of the “n” MMEs in the MME pool, having the standby MME take over responsibility for the failed MME.

12. The method as described in claim 11 wherein the given data is user state data associated with an active MME in the MME pool.

13. The method as described in claim 12 wherein the user state data includes one of: Mobility Management (MM) context of registered User Equipment (UE), and EPS Session Management (SM) information for User Equipment.

14. The method as described in claim 11 wherein the given data is configuration data associated with an active MME in the MME pool.

15. The method as described in claim 11 wherein the given data is connected eNodeB (eNB) context and state information.

16. The method as described in claim 11 further including recovery the failed MME as a new standby MME.

17. The method as described in claim 16 further including continuing the journaling step using the new standby MME.

18. The method as described in claim 11 wherein the standby MME also is associated with a second MME pool.

19. The method as described in claim 11 wherein the MME pool includes a second standby MME.

20. The method as described in claim 11 wherein “n” is determined by a number of subscribers served by the other MMEs and a number of S1 interface connections supported by each eNodeB (eNB) associated with the standby MME.
